(19) United States
(12) Patent Application Publication
(10) Pub. No.: US 2009/0293352 A1
(43) Pub. Date: Dec. 3, 2009

(54) Trellis

(75) Inventor: Joseph Spencer, Toledo, OH (US)

Correspondence Address: PURDUE LAW OFFICES;2735 N. HOLLAND-SYLVANIA ROAD, SUITE B-2, TOLDEO, OH, 43615, US

(73) Assignee: Tencom PGP, Ltd., Holland, OH (US)

(21) Appl. No.: 12/156,142

(22) Filed: May 30, 2008

(51) Int. Cl. A01G 17/06

(52) U.S. Cl. 47/46; 47/47

(57) ABSTRACT

A trellis is disclosed. The trellis has a base, spaced flexible arms rising generally vertically upwardly and outwardly from the base to free ends, and two spacers. There are openings in each of the spacers in which the arms of the trellis are slidable. The walls of the openings in the spacers engage the flexible arms frictionally, exerting a force which opposes sliding movement of the spacers relative to the flexible arms.

### BACKGROUND OF THE INVENTION

1. Field of the Invention

The present invention is a support structure that is especially suited for service as a trellis. More particularly, the invention is a trellis assembly which, in an un-erected state, is quite compact in two dimensions and, when erected, is quite substantially dimensioned in two dimensions. The trellis can be erected by hand without the need for tools or adhesives.

2. Description of the Prior Art

Trellises have been known for many years, being disclosed, for example, in the following U.S. patents:

| US patent | Date | US patent | Date |
|---|---|---|---|
| 166,766 | Aug. 17, 1875 | 890,948 | Jun. 16, 1908 |
| 1,311,136 | Jul. 22, 1919 | 1,592,764 | Jul. 13, 1926 |
| 1,653,263 | Dec. 20, 1927 | D83,802 | Mar. 31, 1931 |
| 1.835.092 | Dec. 8, 1931 | 1,953,638 | Apr. 3, 1934 |
| 2,418,151 | Apr. 1, 1947 | 2,467,265 | Apr. 12, 1949 |
| 2,725,676 | Dec. 6, 1955 | 2,799,122 | Jul. 16, 1957 |
| 3,119,202 | Jan. 28, 1964 | 3,166,869 | Jan. 26, 1965 |
| 4,999,944 | Mar. 19, 1991 | | |

A trellis is a structure, often made from interwoven pieces of wood, bamboo or metal that is made to support a climbing plant or plants. There are many types of trellis for different places and for different plants, such as sweet peas, grapevines and ivy.

A trellis can also refer to a structure, usually made from interwoven wood pieces, attached to the roof or exterior walls of a house (sometimes called a pergola). While metal trellises are typically very ornate, they may not be the best choice for many vining plants. As the sun heats the metal, it gets very hot, and actually stunts the growth of many vines. For tender plants, such as sweet peas, beans, and morning glories, wood or string are often the preferred choices.

### SUMMARY OF THE INVENTION

The instant invention is based upon the discovery of a new trellis construction. The trellis comprises a base, a plurality of spaced flexible arms rising generally vertically upwardly and outwardly from the base in which they are fixed to divergent free ends, and first and second spacers. Both of the spacers have spaced openings in which the free ends of the flexible arms are slidably engaged with the spacers, and there is at least one relative position of the arms and the spacers where frictional engagement between the edge defining at least one of the openings on one or more spacers is enough to support at least one of the spacers on at least one of the arms.

It is, therefore, an object of the invention to provide an improved trellis construction.

It is another object to provide a trellis which comprises a plurality of spaced flexible arms rising generally vertically upwardly and outwardly from a base to free ends, and removable spacers having spaced openings in which the flexible arms are slidably engaged with the spacers.

It is a further object of the invention to provide a trellis construction that can be broken down to a small size for transportation.

It is yet a further object of the invention to provide a trellis construction that can be assembled or erected without tools.

Other objects and advantages will be apparent to one skilled in the art from the description herein, reference being made to the attached drawings.

### BRIEF DESCRIPTION OF THE DRAWING FIGURES

FIG. 1 is a view in perspective showing an erected trellis according to the invention.

FIG. 2 is a plan view of a portion of a bottom support which supports flexible arms of the trellis.

FIG. 3 is a view in elevation of a portion of the bottom support of FIG. 2.

FIG. 4 is a plan view of a first spacer which helps maintain the flexible arms of the erected trellis in spaced relationship.

FIG. 5 is a view in elevation of the spacer of FIG. 4.

FIG. 6 is a plan view of a second spacer which helps maintain the flexible arms of the erected trellis in spaced relationship.

FIG. 7 is a view in elevation of the spacer of FIG. 6.

FIG. 8 is a plan view of the bottom support and the flexible arms of the un-erected trellis of the invention, showing the arms in an unspaced condition.

FIG. 9 is a vertical sectional view showing the engagement between a spacer and an arm of the trellis, when erected, according to the invention.

### DETAILED DESCRIPTION OF THE INVENTION

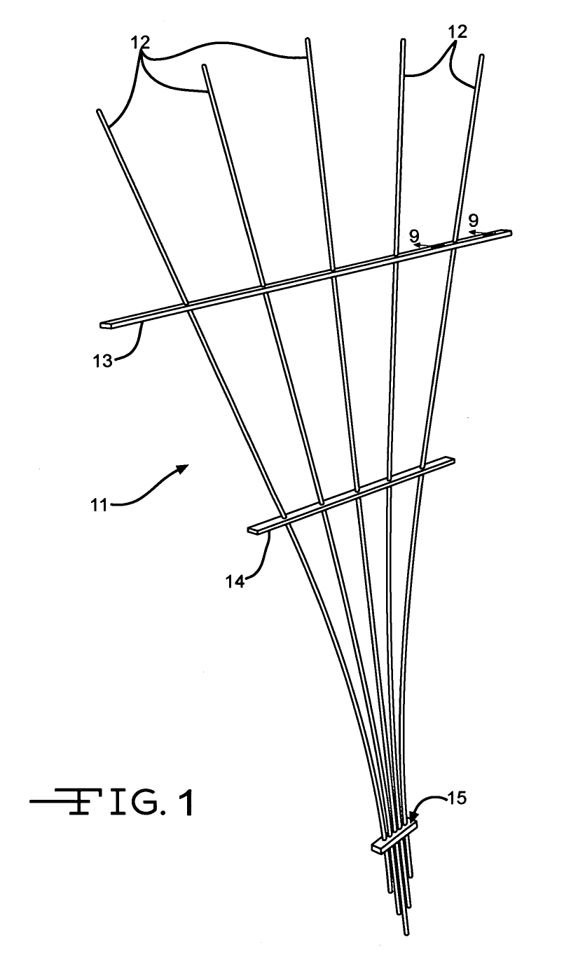

Referring now in more detail to the drawings, an erected trellis according to the invention is indicated generally at 11 in FIG. 1. The trellis 11 is composed of flexible arms 12, a first, upper spacer 13, a second, lower spacer 14, and a base or bottom support 15. The arms 12 pass through openings in the bottom support 15, through openings in the spacer 14 and through openings in the spacer 13. When the trellis 11 is erected, the outer ones of its arms 12 diverge outwardly to an appreciable extent (see, also, FIG. 9), and the central one of the arms 12 extends essentially vertically, while the arms 12 adjacent to the central one of the arms 12 diverge outwardly to a lesser extent than do the outer ones of the arms 12. The base or bottom support 15 is adhered or otherwise fixed or secured to the arms 12 to maintain them in a fixed relationship to each other and to the base 15. Preferably, when the trellis is un-erected, as shown in FIG. 8, the arms 12 are closely adjacent to and substantially parallel to each other.

In a preferred embodiment, the arms 12 are ¼ inch in diameter and they are made of glass fibers and resin by a pultrusion process. The arms 12, as shown in FIG. 8, are graduated in length, outer ones 18 of the arms being 63 inches long; middle ones 19 being 67 inches long; and the other two arms 20 being 65 inches long. Arms 12 having different lengths can also be accommodated. The openings 16 have a diameter that is larger, but preferably only slightly larger, than the diameter of the arms 12, preferably ranging, when the arms 12 have a nominal diameter of ¼ inch, from 0.260 to 0.265 inch to accommodate glue.

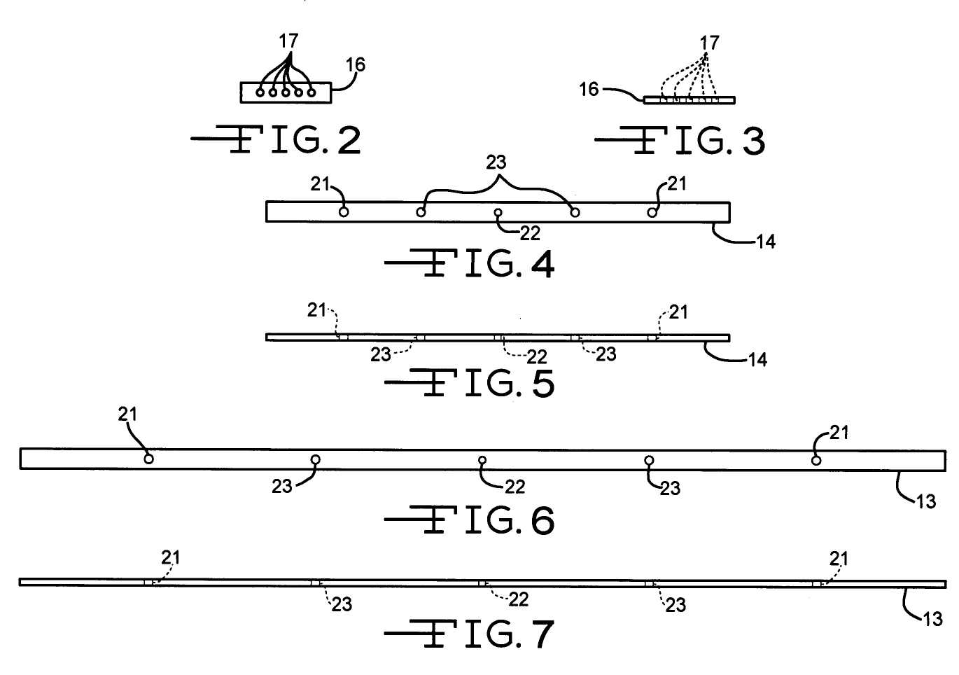

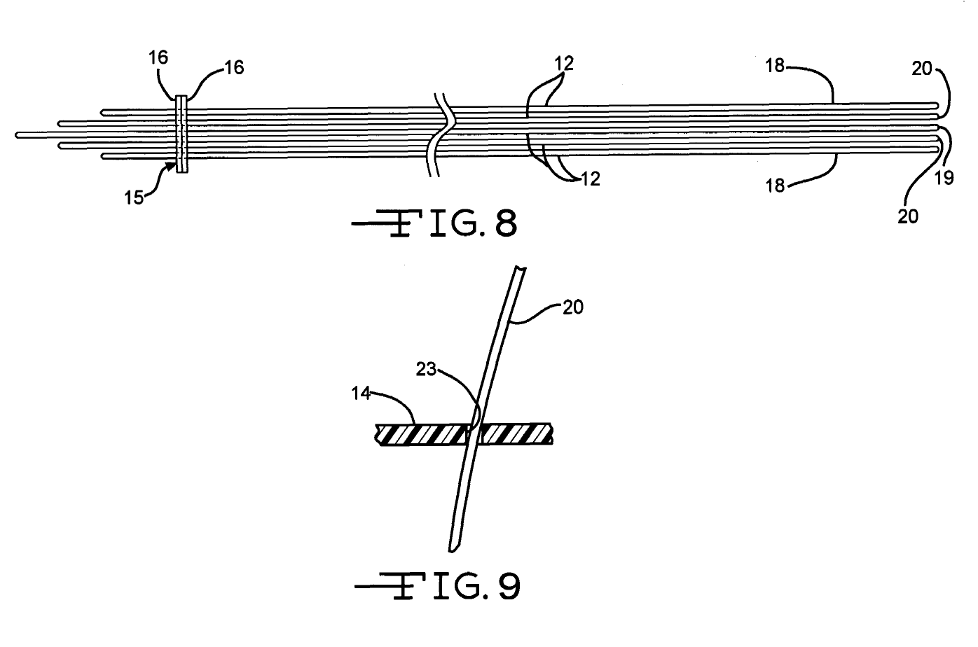

The first step in producing the trellis 11 is to provide a base 15 which may be assembled from two like brackets 16, which are shown in FIGS. 2 and 3, and to secure portions of the flexible arms 12 to the base 15, to produce the structure shown in FIG. 8. As can be seen in FIGS. 2 and 3, the brackets 16 have holes 17 which extend therethrough, and are aligned in the base 15. It is preferred that the holes 17 be slightly larger in diameter than the diameter(s) of the arms extending through them so that there is a gap that can be filled by an adhesive, usually an epoxy (not shown). An epoxy adhesive is also preferred for securing the brackets 16 to each other to produce the base 15. Production of the un-erected trellis assembly shown in FIG. 8 requires no more than inserting appropriately sized ones 18, 19 and 20 of the arms 12 in the respective ones of the openings 17 in the two brackets 16, applying an adhesive to at least one of the facing surfaces of the brackets 16, bringing the brackets 16 together and supporting the pieces in substantially the positions shown in FIG. 8 while the adhesive sets. When the brackets 16 are brought together, this will urge adhesive out from between the facing surfaces of the brackets 16 and some of it will be urged into the interfacing portions of the arms 12 and walls which define the openings in the brackets 16, thereby securing the arms 12 to the bottom support 15 and vice-versa. After the adhesive sets, the arms 12 will, preferably, extend in substantially parallel relationship with each other substantially as shown in FIG. 8. This is a compact arrangement especially well suited for packaging and shipping the un-erected trellis which would include at least one spacer and, preferably, at least the first and second spacers 13 and 14.

The second step in producing the trellis 11 involves providing at least one and, preferably, at least two spacer brackets 13 and 14. There are openings in the brackets 13 and 14 for the arms 12 and the openings are graduated. In the case where the arms have nominal diameters of ¼ inch, it is preferred that outer ones of the openings 21 have diameters of 0.332 inch. It is preferred that center openings 22 have diameters of 0.257 inch, and it is preferred that other openings 23, between openings 21 and 22, have diameters of 0.316 inch.

The third step in producing the trellis 11 involves assembling the spacer brackets 13 and 14 with the arms 12. The trellis 11 is erected by inserting the arms 18 into and through the openings 21 in the brackets 14 and 13; inserting the arms 20 into and through the openings 23 in the brackets 14 and 13; and inserting the arm 19 into and through the opening 22 in the brackets 14 and 13. The arms 12 will be spread apart by this action, causing the free ends of the arms 12 to diverge and causing the arms 18 and 20 to become crooked within in the openings 21 and 23, respectively, in the spacers 13 and 14. As the brackets 14 and 13 are moved generally towards the base or bottom support 15, the arms 18 and 20 will become more crooked within the openings 21 and 23 until at least one of the arms 18 and 20 becomes frictionally wedged within a corresponding opening in one or both of the spacers 13 and 14. An example of this is shown in FIG. 9 where the arm 20 extends through the opening 23 in the lower spacer 14. The arm 20 is crooked and, as a consequence, there is frictional engagement between portions of the arm 20 and portions of the spacer 14 in the vicinity of the opening 23. A plurality of such engagements between the arms 12 and the spacers 13 and 14 give structural integrity to the erected trellis 11, as shown in FIG. 1, and serve to maintain the trellis 11 in its erected condition.

It is preferred that the diameters of the arms 12 be the same and that the diameters of the holes 17 be the same. It is also preferred that the cross sections of the brackets 16 and of the spacers 13 and 14 be the same so that the trellis 111 can be produced from only two kinds of stock. However, it will be appreciated that the arms 12 can have a cross section other than round, such as polygonal.

The arms 12, the spacers 13 and 14 and the brackets 16 can all be produced in conventional pultrusion apparatus, for example, from glass fibers and a suitable resin. Other materials may be used.

It will be appreciated that considerable variation from the specific details of the invention as disclosed above is possible without departing from the spirit and scope thereof as defined in the following claims.

I claim:

1. A trellis comprising
a base,
a plurality of spaced flexible arms rising generally vertically upwardly and outwardly from said base to free ends,
spacers having spaced openings in which said arms are slidably engaged, adjacent their free ends, with said spacer means, means operable to increase the resistance to sliding, upward movement beyond a predetermined limit of said spacer means relative to said arms, second spacer means having spaced openings in which intermediate portions of the flexible arms are slidably engaged with said second spacer means, and means operable to increase the resistance to sliding, upward movement beyond a predetermined movement of said second spacer means relative to said arms.

2. In a trellis construction as claimed in claim 1, the improvement wherein said spacer means is a longitudinally extending member which extends across said flexible arms, and wherein the walls which surround the openings in the spacer means constitute the means operable to increase the resistance to sliding, upward movement of said spacer means relative to said arms.

3. In a trellis construction as claimed in claim 2, the improvement wherein said second spacer means is a longitudinally extending member which extends across said flexible arms, and wherein the walls which surround the openings in the second spacer means constitute the means operable to increase the resistance to sliding, upward, movement of said second spacer means relative to said arms.

4. A trellis construction comprising
a base support,
a plurality of flexible arms secured to and supported in said base in spaced apart relationship to each other and
at least one spacer having a plurality of openings for receiving said flexible arms and operable, when moved towards said base support with said arms received in the openings, to spread the free ends of said arms,
wherein, when said arms are spread by said at least one spacer, some of said arms become cocked within their respective openings and frictionally engage said at least one spacer.

5. The trellis construction claimed in claim 4 which comprises two of said spacers.

6. The trellis construction claimed in claim 4 wherein said arms have a circular cross-section.
